(19) United States
(12) Patent Application Publication
(10) Pub. No.: US 2026/0245044 A1
(43) Pub. Date: Aug. 20, 2026

(54) NEXT-GEN REFERENCE CHECKING PLATFORM WITH SECURE DIGITAL CREDENTIAL MANAGEMENT FOR STUDENTS AND PROFESSIONALS

(71) Applicant: PureVi Tech Solutions Inc., Ottawa (CA)

(72) Inventor: Naleem Badurdeen, Ottawa (CA)

(21) Appl. No.: 19/054,888

(22) Filed: Feb. 16, 2025

(51) Int. Cl. G06Q 10/1053

(52) U.S. Cl. CPC G06Q 10/1053

(57) ABSTRACT

This invention presents an Automated Reference Check SaaS Platform designed to simplify and optimize the process of collecting and managing professional, academic, rental, and character references. The platform enables candidates and students to collect references tailored to their exact needs (e.g., job-specific references such as “Accountant” or academic endorsements for “higher education”) and share them with employers, academic institutions, or other organizations when needed. This unique feature ensures that references are always relevant and aligned with the candidate's specific requirements, setting the platform apart from competitors. The platform enables job candidates, students, tenants, and volunteers to securely request, gather, and share references from various referees. Additionally, it allows university and college students to request, collect, and securely manage their certificates and transcripts, ensuring these documents remain tamper-proof and accessible for use in academic or professional scenarios. These references and documents are analyzed using artificial intelligence to generate outputs including employability scores, academic potential assessments, sentiment analysis, bias detection, and fraud detection. Key advantages of the invention include multilingual support, data privacy compliance with international regulations (such as GDPR, CCPA, and PIPEDA), and the ability for referees to maintain the integrity and confidentiality of their responses. The platform significantly enhances the efficiency of the reference-checking and document management process, improving data quality and decision-making for all parties involved.

### FIELD OF INVENTION

This invention relates to software as a service (SaaS) application, specifically systems that streamline the process of reference checks across diverse contexts. The invention addresses significant challenges in traditional reference-checking processes, such as delays caused by inefficient communication between organizations and referees, data privacy and security risks, language barrier, and the lack of standardized questioning, which can lead to misinterpretation of responses.

This centralized platform facilitates the management of references across various scenarios, including employment, academic endorsements, rental agreements, character references, and client referrals. By extending its application beyond employment, the platform provides a versatile and comprehensive solution for gathering endorsements and insights in various contexts.

In addition to reference management, the platform offers a unique feature that allows university and college students to request and securely obtain their official certificates and transcripts. Educational institutions digitally upload these documents to the portal, where they are securely stored in a tamper-proof format using encryption technologies. Students can access their documents in the future without needing to contact the institution. To ensure authenticity and integrity, students are unable to alter or edit the documents. This feature enhances accessibility while maintaining compliance with institutional and legal standards for security and reliability.

In today's landscape, individuals often need references for various purposes beyond employment. University professors may provide academic recommendations, landlords may require rental references, and organizations may request character references for volunteer work.

However, the traditional reference process is often inefficient. Candidates typically share referee details with organizations, which then collect references independently. This process can be time-consuming due to referee availability, inconsistent data collection, and varying response quality. Additionally, referees may find the process cumbersome, leading to disengagement or reluctance to respond.

This invention provides a centralized platform to efficiently manage references from various sources, including employment, rental, client, character, and academic references. Candidates can request references at any time, eliminating the need to wait until they are required. Once referees submit their feedback, candidates receive a notification of completion but cannot view the content, ensuring authenticity and impartiality. By consolidating all references in one place, the platform enhances the quality and reliability of collected information. Additionally, the system maintains a complete audit trail, ensuring transparency and integrity.

Additionally, the platform enables students to securely manage their academic certificates and transcripts, providing a reliable and accessible solution for credential management. Candidates can request their academic documents immediately after completing their studies and reuse them as needed, anytime and anywhere, without having to contact their academic institution repeatedly.

Further, integrating advanced technologies such as artificial intelligence enables the analysis of referee responses, generating valuable insights into employability, character assessment, or academic potential. The platform ensures the process complies with data privacy regulations, including GDPR, CCPA, PIPEDA, and others. The invention's focus on security and automation not only enhances the user experience for candidates and referees but also streamlines decision-making processes for employers, academic institutions, and other organizations, ensuring that comprehensive and actionable data inform critical decisions.

### BACKGROUND OF INVENTION

Traditionally, conducting reference checks has posed significant challenges, rendering it time-consuming, cumbersome, and often inefficient. This challenge extends beyond employment, as references are required in various contexts, such as academic endorsements, rental agreements, and character assessments. Candidates are often responsible for providing referee contact information to organizations. The organizations contact the referee via phone call or email. The referees who may have varying schedules, availability, and willingness to respond promptly can cause delays. These issues result in protracted timelines that frustrate all parties involved, including employers, landlords, academic institutions, and recruitment agencies.

The experience for referees is similarly burdensome. Many referees report feeling overwhelmed by frequent requests, whether for employment, academic recommendations, or rental references, reducing their ability to provide thoughtful and effective responses. In some cases, they may struggle to recall the candidate or their contributions, especially after a long gap. Language barriers can also pose challenges when referees are not fluent in the requested language. These concerns further exacerbate the inefficiencies in reference-checking processes.

Compounding these challenges are significant legal and ethical concerns regarding data privacy and compliance. Modern data protection regulations, such as the General Data Protection Regulation (GDPR) and the California Consumer Privacy Act (CCPA), impose stringent requirements on how personal data is collected, stored, and shared. Many existing systems for managing references, across all contexts, lack adequate safeguards and transparent processes, risking unintentional violations that could result in legal repercussions. Organizations relying on these references face potential liabilities if sensitive information is improperly handled, endangering their reputation and finances.

Additionally, existing systems often lack centralized management, leading to fragmented reference data spread across multiple platforms. Without a unified solution, candidates cannot easily request, store, or manage their references and academic documents in one place. This fragmentation makes it difficult to access and analyze reference information effectively. As a result, organizations may struggle to assess a candidate's suitability due to incomplete data, potentially overlooking critical insights that could impact hiring, rental decisions, or academic admissions.

The absence of standardized questioning in reference requests also leads to inconsistencies in feedback quality. Referees may interpret vague or generic questions differently, resulting in subjective or irrelevant responses that fail to accurately reflect a candidate's skills, character, or reliability.

This variability can introduce bias into evaluations, affecting the fairness of decisions. In today's competitive environments, where quick and informed decision-making is crucial, traditional manual reference-checking processes fall short. Employers, landlords, and academic institutions alike require actionable, unbiased, and comprehensive data promptly, which existing methods are ill-equipped to deliver.

Moreover, students often face challenges when requesting and managing their academic documents, such as certificates and transcripts. Current systems are often decentralized and inefficient, requiring students to repeatedly interact with academic institutions for access to these records. The risk of delays of applications, lost documents, or unauthorized alterations further complicates the process.

The present invention addresses these challenges by incorporating a feature that allows university and college students to securely request and obtain their official certificates and transcripts. These tamper-proof documents are stored digitally, ensuring their authenticity while providing students with accessible and reliable credentials for future use. This addition complements the platform's reference-checking capabilities, offering a holistic solution for managing both endorsements and critical documents.

In summary, the landscape of reference checks—whether for employment, academic, rental, or volunteer purposes—is fraught with inefficiencies, compliance risks, and inconsistencies that hinder both candidates and referees. Similarly, the management of academic documents presents additional obstacles for students. The need for an innovative solution that addresses these issues is clear. The present invention offers a transformative approach by providing an automated reference-checking platform, integrating advanced technologies to streamline the process, ensuring data security and compliance, and improving the overall experience for all involved parties.

### SUMMARY OF INVENTION

The present invention provides an innovative automated reference-checking platform designed to transform the process of collecting, managing, and sharing professional references and endorsements securely and efficiently. By centralizing all aspects of the reference-checking process, this platform supports a broad range of reference needs, including employment, academic endorsements, rental agreements, and character references for volunteering or other purposes.

In addition to managing references, the invention introduces a unique feature allowing university and college students to request and securely obtain their official certificates and transcripts. These documents are digitally stored, tamper-proof, and immutable, ensuring their authenticity and integrity. Students can access these records when needed, avoiding the traditional delays and inefficiencies associated with document retrieval. This feature addresses a critical need for accessible and reliable credential management while ensuring compliance with institutional and legal standards.

Candidates and students can seamlessly select referees tailored to their exact needs, such as job-specific references (e.g., “Accountant”) or academic endorsements (e.g., “higher education”), ensuring that the feedback aligns precisely with the criteria required for the intended purpose. This unique feature allows candidates to collect and manage references at any given time and share them with employers, academic institutions, or other organizations when needed, providing unparalleled flexibility and relevance in the reference-checking process. The platform also facilitates the creation of customizable question sets, allowing employers and academic institutions to define specific criteria tailored to their objectives, enhancing the relevance and quality of the references collected.

Once a reference request is made, referees receive an email invitation to the portal, where the referee has to validate his/her authenticity and sign up to the portal. Without invitation, the referee cannot sign up to the portal. Once referees'email and phone numbers are validated, signed in to the portal, the referee is prompted to complete the process via a user-friendly interface. The platform supports various features, such as multiple-choice question and answers, and voice-to-text capabilities for open-ended questions, to enable referees to provide feedback in a simplified way at their convenience. The referee could answer in their proficient language. This flexibility significantly reduces the burden on referees, incentivizing them to participate willingly and deliver thoughtful, comprehensive insights, whether the request relates to employment, academic evaluation, rental suitability, or character assessments.

The invention incorporates sophisticated artificial intelligence algorithms that analyze the completed reference responses. These AI-powered analyses yield actionable insights, including:
Employability Scores: Quantitative ratings that assess a candidate's potential fit for a specific position based on reference feedback.
Sentiment Analysis: An evaluation of the emotional tone within referee responses, which can indicate the overall sentiment about the candidate.
Bias Detection: Algorithms designed to identify potential biases (positive or negative) in referee feedback, promoting fairness and objectivity across all reference scenarios.
Fraud Detection: Mechanisms that uncover inconsistencies in reference data that may suggest fraudulent or misleading information.
Red Flag Detection: Algorithms designed to identify potential red flags such as poor teamwork, unprofessional behavior, or other traits that could potentially disrupt workplace dynamics. This due diligence protects companies from potential liabilities, saving them time, effort, and resources in the long term.

This automated approach not only expedites the reference-checking process but also enhances the reliability and integrity of the information gathered. The platform ensures that referees'responses remain confidential from candidates, fostering an environment of transparency and trust between all parties involved.

Additionally, the invention emphasizes compliance with international data privacy regulations such as GDPR, CCPA, PIPEDA and others, ensuring robust protection for personal information throughout the reference-checking process. By implementing complete encryption of data in transit and at rest, the platform guarantees secure handling of sensitive information, providing peace of mind for candidates, referees, employers, and other organizations.

Overall, this automated reference-checking platform simplifies the process for candidates, referees, employers, academic institutions, landlords, and recruitment agencies by reducing time delays, improving data quality, enabling data-driven decisions, and ensuring adherence to legal requirements. By transforming a traditionally cumbersome task into a streamlined, efficient, and secure process—and enabling students to manage their academic documents—the invention represents a significant advancement in the management of professional, academic, and personal references across various contexts.

### BRIEF DESCRIPTION OF DRAWINGS

FIG. 1: A Data flow chart illustrating the job seekers, student's and individual process of requesting and managing references.

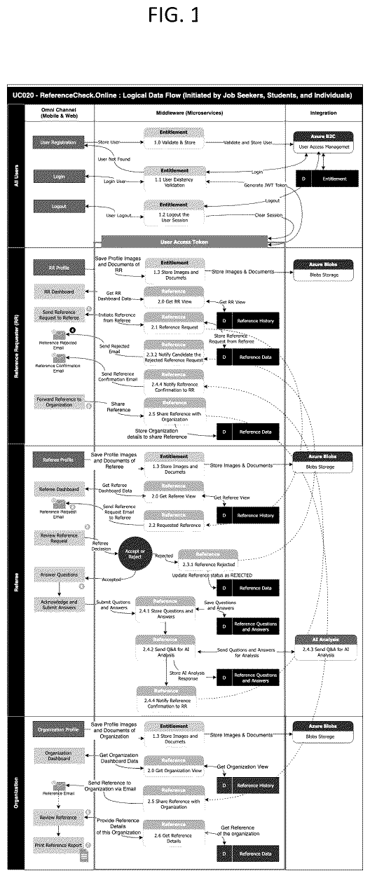

FIG. 2: A Logical data flow illustrating an organizations data automated flow.

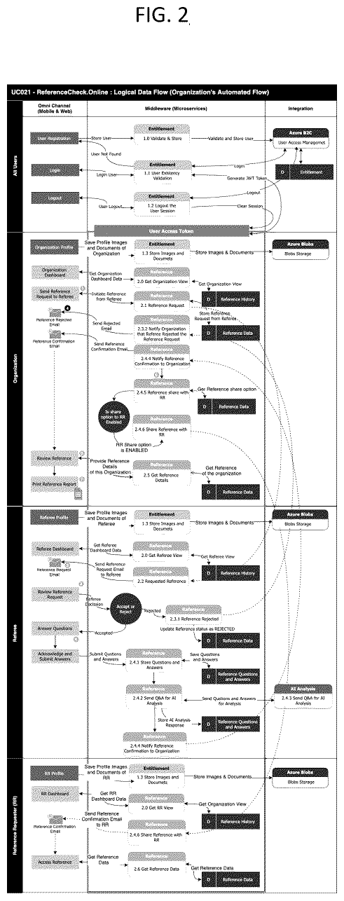

FIG. 3: A Logical data flow illustrating an organizations manual data flow.

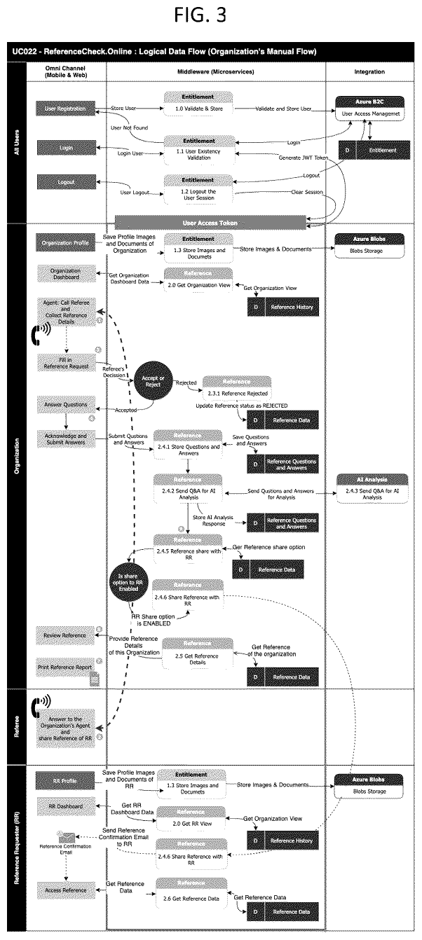

FIG. 4: A Logical data flow chart illustrating a student's endorsement data flow.

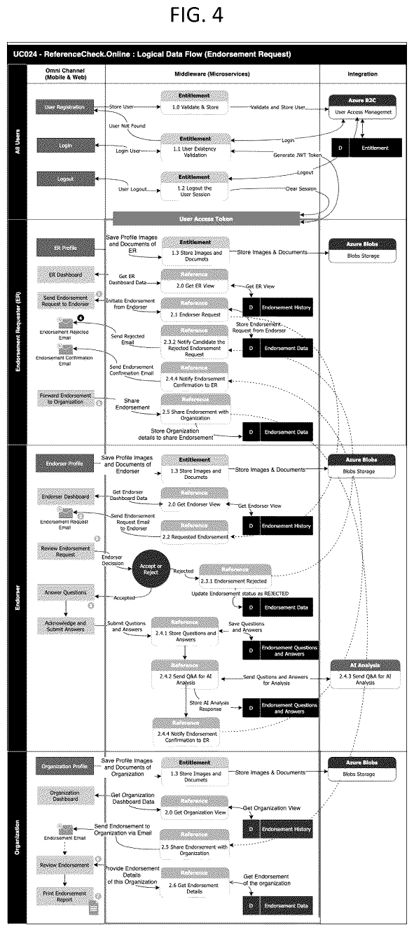

FIG. 5: A Logical data flow chart illustrating a student's credential management data flow.

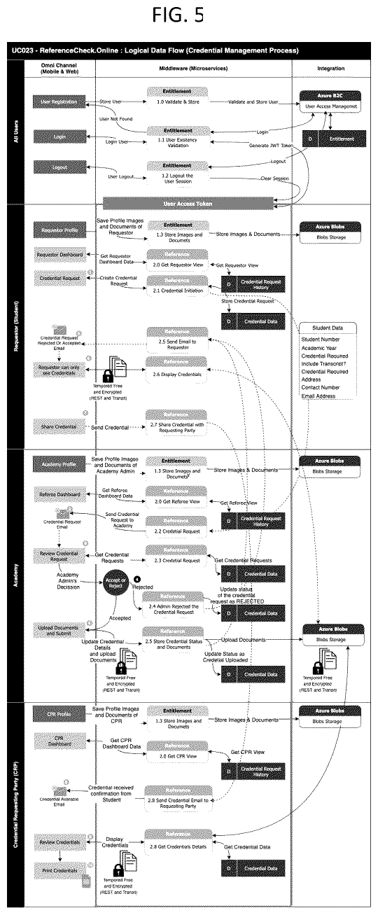

FIG. 6: A Data flow chart illustrating the AI model training process.

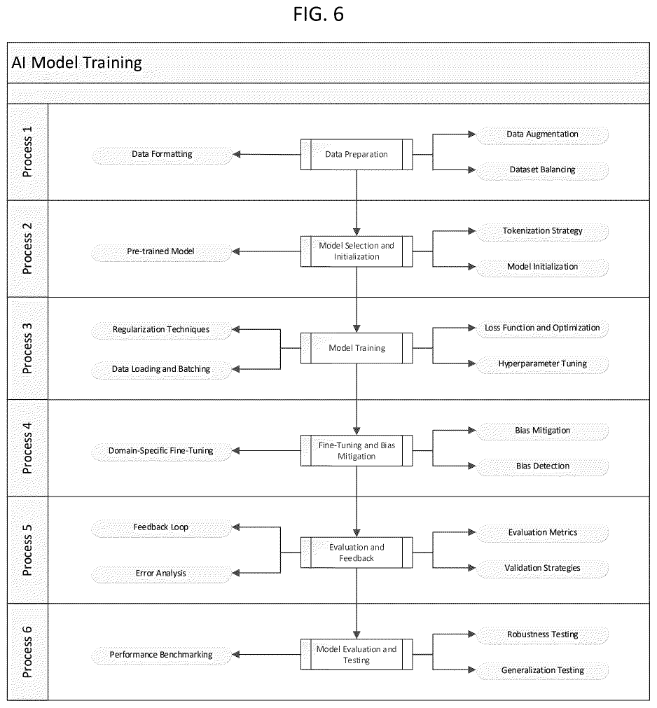

FIG. 7: A process flow chart illustrating the AI API integration process.

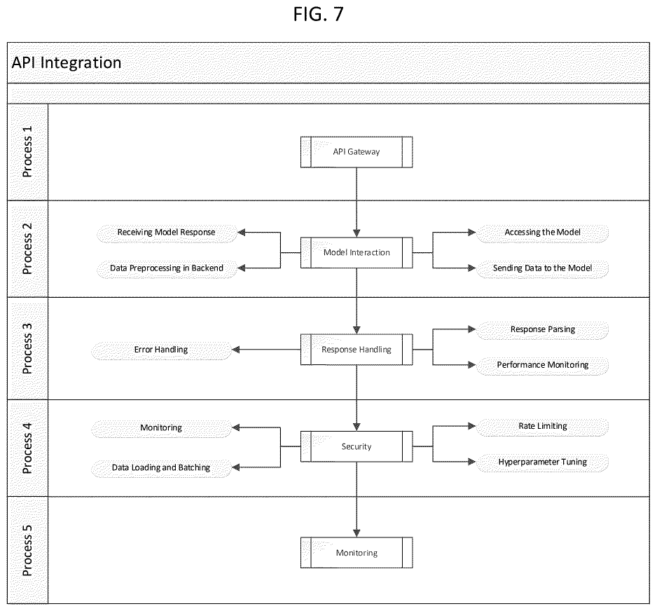

### DETAILED DESCRIPTION OF INVENTION

The Automated Reference Check SaaS Platform is an innovative solution meticulously designed to streamline the reference-checking process for candidates, referees, and employers. This platform supports a wide variety of reference needs, including employment, academic endorsements, rental agreements, and character references for volunteer work or other purposes.

Additionally, it incorporates a unique feature enabling university and college students to securely request, obtain, and manage their official certificates and transcripts. These documents are tamper-proof and digitally stored, ensuring accessibility and authenticity for students while maintaining robust security against unauthorized modifications.

This feature complements the platform's other capabilities, creating a comprehensive tool for managing both references and essential academic documents. Below are the key features and additional benefits of the platform:

1. Employer Dashboard: The employer dashboard acts as a comprehensive platform for organizations to streamline and manage their reference-checking processes effectively. With an intuitive and user-friendly interface, employers can oversee all candidate references in real time, track referee responses, and monitor the progress of reference verifications. This dashboard simplifies decision-making by consolidating feedback into actionable insights, highlighting key indicators such as employability scores, potential red flags, and bias analysis. It also ensures compliance with privacy laws and provides employers with tools to securely store and retrieve reference data when needed. Whether for recruitment, tenant screening, or volunteer placement, the employer dashboard enhances efficiency and reliability in the reference-checking process. The employer can also share the reference with the candidate, allowing them to reuse it without needing to contact the referee again.

2. Candidate Dashboard: The candidate dashboard serves as a centralized hub where job seekers, students, renters, or volunteers can efficiently manage their reference-checking tasks. Candidates and students can collect references tailored to their exact needs, such as job-specific references (e.g., “Accountant”) or academic endorsements (e.g., “higher education”), and share them with employers, academic institutions, or other organizations when needed. This unique feature ensures that references are always relevant and aligned with the candidate's specific requirements, setting the platform apart from competitors. It offers a visually appealing interface that provides candidates with real-time updates on reference requests, allowing them to track which referees have responded, the completeness of the feedback received, and the overall status of their applications. For students, this dashboard also includes a section dedicated to managing their certificates and transcripts, ensuring quick access to these critical documents when needed. Candidates can easily share their references with any number of employers and organizations when needed. References can only be shared with verified organizations, preventing misuse by individuals with free email accounts.

3. Referee Interface: The secure referee interface is designed with functionality and simplicity in mind. Referees can manage all reference requests in one location, making it easy to act on requests promptly. Features such as email notifications alert referees of incoming requests, and built-in reminders ensure they are aware of deadlines. Additionally, the interface integrates helpful tips and guidelines to assist referees in providing constructive feedback, fostering a positive experience for them, whether they are providing academic, rental, employment, or character references.

4. Professor/Academic Interface: The secure academic interface simplifies managing student reference requests with features like email notifications, reminders, and guided tips. Professors can easily track and complete ensuring a seamless process for academic, internship, or employment recommendations. The platform is designed to save time and support student success.

5. AI Analysis Engine: The AI analysis engine is a transformative feature of the platform, capable of processing large volumes of data quickly. By leveraging large language model (LLM) and Langchain framework & OpenAI, along with machine learning algorithms, the engine provides insightful analyses that add qualitative value to reference checks. Beyond traditional metrics like employability scores and sentiment analysis, the engine can identify patterns and trends across multiple references. This allows employers to gauge a candidate's consistency in different work environments, academic settings, rental situations, or volunteer roles. The engine can also validate certificates and transcripts to ensure they remain unaltered and authentic.

6. Digital Credential Management for Students: University and college students can securely request and collect their official certificates and transcripts through the platform. These documents are stored in a tamper-proof format, ensuring that their integrity remains intact. Students retain full access to their credentials, which they can present as needed for job applications, academic admissions, or other purposes. The system ensures that these documents cannot be altered or edited, providing peace of mind to institutions and organizations that rely on their authenticity.

7. Multilingual Support: The platform's multilingual support is a critical enhancement that promotes inclusivity and broadens the reach of the reference-checking process. Referees from diverse linguistic backgrounds can communicate effectively, while employers gain seamless access to translated responses. Similarly, students from international backgrounds can manage and present their credentials in their preferred language, ensuring clarity and accessibility.

8. Question Templates: The extensive library of question templates provides an invaluable resource for employers, and organization seeking to tailor their reference inquiries to specific roles or purposes. By using these professionally designed templates, employers and organizations can formulate questions that elicit detailed and relevant insights from referees. Employment questions are organized by industry, job category, and job name, making it easy to find the questions needed for the specific job context.

9. Data Privacy Compliance: Recognizing the importance of data security, the platform includes built-in compliance measures that adhere to various international data privacy regulations, such as GDPR, CCPA, and PIPEDA. End-to-end encryption, coupled with secure data storage practices, ensures that sensitive information—including certificates, transcripts, reference data and personal data—is protected at every stage. The platform enforces strict access controls, ensuring that only authorized users can view sensitive data while maintaining transparency and accountability.

10. Single Account Functionality: The single account functionality streamlines the user experience for both candidates and referees. Candidates can integrate references across multiple applications or scenarios—whether for employment, academic admissions, rental agreements, or volunteer opportunities—while also maintaining their certificates and transcripts in one location.

11. Data Ownership and Security: Candidates, including students, retain full control over their reference data, certificates, and transcripts. This ensures they can manage access to these resources as needed, safeguarding personal and academic information while reinforcing a sense of agency over their professional and academic profiles.

12. Analytical Reporting Dashboard for Employers and Institutions: Beyond the immediate analysis provided by the AI engine, the platform features an analytical reporting dashboard designed for employers, academic institutions, landlords, or recruitment agencies. This dashboard consolidates insights into multiple reference checks, credentials, and document verifications. This comprehensive reporting capability empowers decision-makers with trends and insights that can influence hiring, admissions, and screening processes.

13. Scalability for Organizations of All Sizes: The platform is designed to scale effectively, accommodating increased volumes of references and academic document requests without compromising performance or security. The SaaS application can be easily integrated with other Applicant Tracking Systems (ATS) or related applications using an API, ensuring smooth data flow and interoperability.

By consolidating these features into a single, cohesive platform, the Automated Reference Check SaaS Platform significantly enhances the reference-checking experience for candidates, referees, and employers while addressing the need for secure academic document management.

### Use Cases

### Use Case 1: Streamlining the Academic Reference and Credential Management Process for a Graduate School Applicant

User: Anya Sharma, a final-year undergraduate student applying to a graduate program in Computer Science at a prestigious university.

Scenario: Anya needs to submit multiple academic references and official transcripts as part of her graduate school application. Traditional methods involve contacting professors individually, waiting for them to submit letters, and requesting transcripts from the university registrar's office—a process that is time-consuming, prone to delays, and potentially error-prone.

Solution: Anya uses the Reference Check Online SaaS Platform.

### Steps

1. Reference Request: Anya logs into the platform, selects the “Graduate School Application” context and identifies the specific requirements for her chosen program. She chooses relevant referees (professors from her undergraduate program) from her institution's verified list and creates personalized request templates that include the institution's required questions. She sends the requests directly through the platform.
2. Referee Participation: Professors receive email invitations to the platform and access a user-friendly interface to provide references. The interface supports multiple choice and open-ended questions, including voice-to-text capabilities to help professors answer concisely and quickly. The system ensures the confidentiality and security of responses.
3. Transcript Request: Simultaneously, Anya requests her official transcripts through the platform's secure credential management feature. Her university has already uploaded the transcript to the platform in a tamper-proof digital format.
4. AI-Powered Analysis: The platform's AI engine automatically analyzes all collected reference letters to provide valuable insights including academic performance skills, research skills, personal traits analysis, identifying potential biases and detecting inconsistencies ensuring that the recommendations are fair and reliable. Also, it analyzes for any fraudulent activity.
5. Transparent Tracking: Anya's dashboard provides real-time updates on the status of both reference requests and transcript retrieval. Ayna shares the reference and the transcript with the graduate admissions committee. Ayna can also view the status of the document sent including confirmation receipt. Furthermore, the platform allows Anya to securely share the same verified references and transcript with other bodies or universities, streamlining future applications.
6. Compliance: The platform ensures compliance with relevant data privacy regulations (GDPR, CCPA, PIPEDA etc.), protecting the privacy of Anya, her referees, and the university.

### Benefits

Efficiency: The entire process is significantly faster than traditional methods.
Convenience: The user-friendly interface simplifies the process for Anya and her referees.
Reliability: The platform ensures data integrity and reduces the risk of errors.
Security: The system adheres to data privacy regulations and protects sensitive information.
Transparency: Anya can track the progress of her application in real time.

This use case highlights the platform's value proposition by showcasing how it streamlines a complex process, improves efficiency, and enhances data integrity for both the applicant and the institution. This positive user experience addresses many of the pain points described in the patent application's background section.

### Use Case 2: International Job Search and Reference Management for a Brazilian Migrant

User: Ricardo Santos, a software engineer in Brazil, is seeking a job in the UK and planning to relocate.

Scenario: Ricardo has a strong professional background but he fears he might face challenges during his job search in UK. In UK references are necessary and unfortunately, Ricardo's manager and team leads does not speak English. Also, there is a significant time zone difference between Brazil and the UK. Recardo is aware of the logistical difficulty of collecting references from previous employers and colleagues while preparing for his move.

Solution: Ricardo utilizes the Reference Check Online SaaS Platform. Steps:
1. Proactive Reference Collection: Before he moved to UK, Ricardo used the platform to request references from his previous employers and colleagues in Brazil. He simply selects his job role and enter referees name and email address and requested reference.
2. Multilingual Support: His referees receive an email invitation. When they joined the platform, they chose Portuguese as their working language. Now the referees are presented with the questions in Portuguese and the provide the references in their native language. The platform's multilingual support eliminates the language barrier.
3. Asynchronous Communication: The time zone difference is mitigated by the asynchronous nature of the platform. Referees can respond at their convenience, regardless of their location or working hours.
4. Centralized Reference Management: Ricardo's candidate dashboard serves as a centralized hub for all his references. He can monitor the completion status, access to complete references.
5. Secure Storage and Sharing: Ricardo's references are securely stored on the platform, ensuring data privacy and compliance. He can easily share them with UK-based employers as needed, without repeatedly contacting his referees.
6. AI-Driven Analysis: When Ricardo shares the references with the employer, they have immediate access to the referees'responses without any delays. They can view the answers in English language. The AI engine analyzes reference feedback, provide the employer a complete insight to the reference with a summary report with employability score, bias analysis, sentimental analysis and any red-flags.

### Benefits

Overcomes Language Barriers: Multilingual support allows seamless communication with referees regardless of their native language.
Manages Time Zone Differences: The asynchronous nature of the platform accommodates the time difference, enabling quick turnaround times.
Efficient Reference Management: The platform allows Ricardo to collect, store, and reuse references efficiently, eliminating repeated requests.
Streamlined Job Search: Ricardo can focus on his job search in the UK without being hampered by logistical challenges.
Data Privacy and Security: The platform safeguards sensitive information and meets data privacy standards.
Improved Insights: The AI-powered analysis report simplifies employers onboarding process.

This use case emphasizes how the platform's features directly address the specific challenges faced by international job seekers, making the job search process easier and more effective.

1. An automated reference check platform that enables job candidates, students, tenants, and volunteers to manage, collect, and share professional references tailored to their exact needs (e.g., job-specific references such as “Accountant” or academic endorsements for “higher education”) in a secure, centralized environment, applicable across employment, academic, rental, and character endorsement scenarios. This unique feature allows candidates to collect and share references at any given time, ensuring relevance and flexibility in the reference-checking process. It also includes provisions for certain collected references that cannot be seen by the candidates, along with restrictions on sharing references only with valid organizations rather than individuals using free email addresses.

2. The platform of claim 1 further enables university and college students to request, collect, and securely manage official certificates and transcripts, providing tamper-proof storage and ensuring that these documents remain unaltered for use in job applications, academic admissions, and other relevant scenarios.

3. The platform of claim 1 analyzes responses from referees using an artificial intelligence engine to generate outputs, including employability scores, bias detection, sentimental analysis, academic potential assessments, character endorsements, and fraud detection reports.

4. The platform of claim 1 includes multilingual support that allows referees to respond in their native language, and the system translates responses for employers, academic institutions, landlords, and other organizations, ensuring clear communication across diverse linguistic backgrounds.

5. The platform of claim 1 complies with international data privacy regulations, such as GDPR, CCPA, PIPEDA, and more and employs end-to-end encryption for data protection, ensuring the security and confidentiality of personal, reference, and academic document data.

6. The platform of claim 1 features a voice-to-text functionality that streamlines referee input, enabling referees to respond more conveniently and efficiently, regardless of the type of reference (employment, academic, rental, or volunteer)

7. The platform of claim 2 ensures that certificates and transcripts requested by students are protected from unauthorized modifications and provides students with easy access to these documents through a secure, user-friendly interface.

8. The platform of claim 1 integrates customizable question templates for employers, academic institutions, landlords, and candidates, enabling tailored reference inquiries and improving the relevance and quality of feedback received.

9. The platform of claim 1 features an analytical dashboard that consolidates data insights from references and academic documents, empowering employers, academic institutions, and other organizations to make informed decisions efficiently

10. The platform of claim 1 allows users to retain full control over their data, enabling candidates to manage access to their references, certificates, and transcripts, thereby ensuring personal and academic information security.

11. The platform of claim 1 includes a single account functionality that integrates reference management and document storage across multiple applications and scenarios, providing a seamless user experience.

12. The platform of claim 1 provides an analytical reporting dashboard that aggregates insights and trends from multiple references and academic documents, facilitating data-driven decision-making for employers and institutions.

13. The platform of claim 1 is scalable, designed to accommodate increased volumes of references and document requests without compromising performance or security, and can be easily integrated with existing Applicant Tracking Systems (ATS) through an API.
